(19) United States
(12) Patent Application Publication
(10) Pub. No.: US 2013/0159435 A1
(43) Pub. Date: Jun. 20, 2013

(54) Method and System for Processing User Contact Information

(71) Applicants: Jian LIU, Beijing (CN); Youlin Li, Beijing (CN)

(72) Inventors: Jian LIU, Beijing (CN); Youlin Li, Beijing (CN)

(73) Assignee: RENREN INC., Grand Cayman (GB)

(21) Appl. No.: 13/607,532

(22) Filed: Sep. 7, 2012

(30) Foreign Application Priority Data
Dec. 20, 2011 (CN) 201110456749.3

(51) Int. Cl. G06F 15/16

(52) U.S. Cl. 709/206; 709/204

(57) ABSTRACT

Embodiments of the present invention relate to a method and a system for processing user contact information. Specifically, there is provided a method for processing user contact information, comprising: obtaining, at a user equipment of a first user, contact information associated with a second user; and initiating a social networking service (SNS) operation between the first user and the second user based on the contact information. Corresponding system is also disclosed. According to embodiments of the present invention, user contact information may be processed in a more effective and intelligent way.

### FIELD OF THE INVENTION

Embodiments of the present invention generally relate to information processing field, and more particularly, relates to a method and system for processing user contact information.

### DESCRIPTION OF THE RELATED ART

In various kinds of devices available for communication, such as a cellular phone, a personal digital assistant (PDA), and a traditional desktop personal computer, users are generally allowed to input contact information of other people. Specifically, besides manually inputting contact information into a device by a user, a business card is an important social medium for carrying, exchanging, and recording contact information. Through exchanging business cards, it is possible to obtain, exchange, and record various kinds of personal information such as name, occupation, title, address, and contact manners (for example, including fixed phone number, mobile phone number, e-mail address, instant messaging account, etc.).

Because traditional business cards are usually based on paper medium, the contact information cannot be directly processed and utilized in an electronic and digitalized manner. It is rather time-consuming and troublesome to input information in a business card into an electronic device such as computer. Thus, the prior art has proposed a solution for automatically scanning and digitalizing a business card. In such a solution, a paper business card may be scanned and the information thereon may be identified (for example, optical character recognition OCR-based recognition technology), thereby digitalizing the information carried on the business card.

In a further known solution, it is proposed to store digitalized business card information at a remote server (for example, storing in the “cloud end” in the cloud computing concept). In this way, the user is allowed to conveniently obtain the digitalized business card information as required anytime and anywhere.

However, in the prior art, after processing the business card information digitally, no further voluntary utilization and exploitation of such digitalized information are available. For example, in the known solutions, when such digitalized contact information is stored in the user device locally or in a remote server, the information will constantly in an idle state, unless the user otherwise explicitly requests for or accesses such information. In other words, the digitalized contact information is not voluntarily utilized to provide potential services for the user.

More specifically, the greatest value and usage of the business card and other contact information lie in the capability of carrying and delivering social information. Thus, when the contact information is digitalized, it is desired to facilitate digitalized interactive activities between the user and other user in a more active and intelligent manner. However, there is no such a technical solution in the prior art. The existing active utilization of a digitalized business card or other contact information is merely limited to send a notification to another user whose business card is added. It is far insufficient to satisfy the increasing demand of network and information-oriented interaction.

Thus, it is needed in the art a technical solution of utilizing digitalized user contact information in a more active manner.

### SUMMARY OF THE INVENTION

In view of the above problems, the present invention provides a novel method and system for processing user contact information.

According to one aspect of the present invention, there is provided a method for processing user contact information. The method comprises: obtaining, at a user equipment of a first user, contact information associated with a second user; and initiating a social networking service (SNS) operation between the first user and the second user based on the contact information.

According to another aspect of the present invention, there is provided a system for processing user contact information. The apparatus comprises: obtaining means configured to obtain, at a user equipment of a first user, contact information associated with a second user; and initiating means configured to initiate a social networking service (SNS) operation between the first user and the second user based on the contact information.

According to the embodiments of the present invention, after the user inputs the contact information of other people in its user equipment, the contact information is not simply stored, but may be utilized to voluntarily find and initiate interactive relations and operations between the user and other users. In particular, such interactive behavior may comprise an SNS website-based operation and interaction. Therefore, effective and intelligent utilization of the user contact information may be significantly facilitated.

### BRIEF DESCRIPTION OF THE DRAWINGS

Through reading the following detailed description with reference to the accompanying drawings, the above and other objective, features and advantages of the embodiments of the present invention will become more comprehensible. In the drawings, a plurality of embodiments of the present invention will be illustrated in an exemplary and non-limiting manner, wherein:

FIG. 1 shows a flow chart of a method 100 for processing user contact information according to an exemplary embodiment of the present invention;

FIG. 2 shows a block diagram of a system 200 of processing user contact information according to an exemplary embodiment of the present invention;

FIG. 3 shows a block diagram of a mobile terminal 300 that is adapted to be used in combination with the embodiments of the present invention; and

FIG. 4 illustrates a block diagram of a computer system 400 that is adapted to be used with the embodiments of the present invention.

Throughout the drawings, like or corresponding numerical signs indicate the same or corresponding parts.

### DETAILED DESCRIPTION OF THE INVENTION

Hereinafter, the principle and spirit of the present invention will be described with reference to various exemplary embodiments illustrated in the drawings. It should be understood that provision of these embodiments is only to enable those skilled in the art to better understand and further implement the present invention, not intended for limiting the scope of the present invention in any manner.

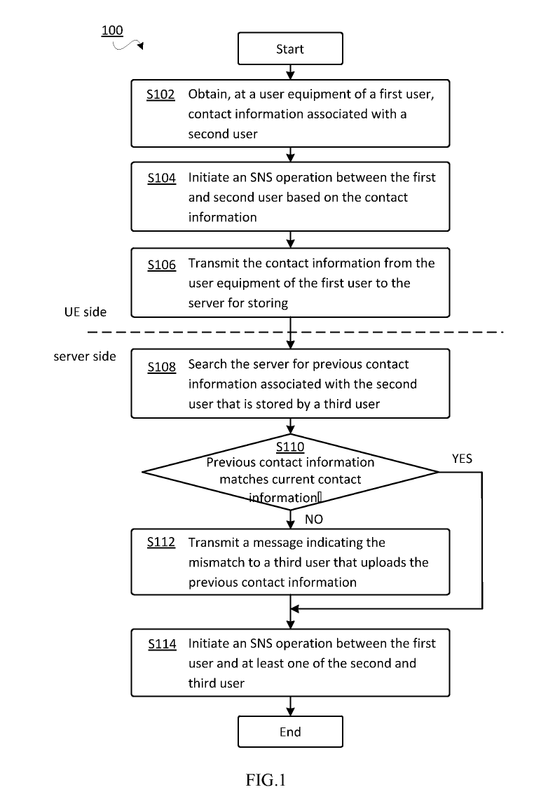

Reference is first made to FIG. 1, where a flow chart of a method 100 for processing user contact information according to an exemplary embodiment of the present invention is illustrated. It should be understood that various steps as illustrated in method 100 may be executed in different order or in parallel, or omitted, or include other additional steps that are not shown.

After start of method 100, at step S102, contact information associated with a second user is obtained at a user equipment of a first user.

According to embodiments of the present invention, the user equipment of the first user may be any appropriate electronic device that has information processing capability and communication capability. Examples of the user equipment include but not limited to: a personal digital assistant (PDA), a mobile terminal, a cellular phone, a smart phone, a laptop computer, and other mobile terminals, or a traditional desktop computing device such as a personal computer PC. It should be understood that the above listed are merely several possible examples and not intended to limit the scope of the present invention. In fact, any device having information processing and network communication capabilities may act as the user equipment in the present invention, whether such device is currently known or future developed.

Specifically, at step S102, the contact information associated with the second user may comprise one or more content items. These content items may involve various kinds of information relating to the second user, for example, including but not limited to one or more of the following: name, occupation, title, address, contact manner (for example, including fixed phone number, mobile phone number, e-mail, instant messaging account, etc.), SNS website account, etc.

According to embodiments of the present invention, at step S102, contact information of the second user may be obtained by various suitable technical means. For example, in some preferred embodiments, the contact information of the second user may be obtained by digitally scanning and recognizing the business card of the second user.

Digitally scanning and recognizing a paper business card may be implemented by utilizing various kinds of suitable technical means that are currently known or future developed. For example, the paper business card may be initially converted into a digital image using image acquisition and capturing technology. This may be implemented, for example, by a camera/scanner provided on the user equipment, and may be alternatively implemented by other device than the user equipment.

Next, data items containing contact information in the business card image may be extracted utilizing digital image processing technology. This may be implemented, for example, based on an image partitioning and content extracting technology. Then, these data items may be subjected to text recognition such as OCR so as to extract text. The extracted text may include information indicating the category of a content item, for example, “phone,” “email”; and also include the specific content information, for example, “13333333333,” “user-1@server-1.com.” Then, the extracted text may be provided to the user equipment of the first user. In particular, in order to ensure the accuracy of the information, the result obtained from recognition processing may be subjected to manual proofreading.

It should be noted that digitalization of a business card may be implemented using any technical means that is currently known or future developed. It is also possible to implement semi-automatically with artificial interference. The scope of the present invention is not limited in this regard.

Obtaining contact information by digitally processing the business card as mentioned above is only an example, and other information obtaining manner is also possible. For example, a first user may input the contact information about the second user into the user equipment of the first user based on the paper business card of the second user obtained by him/her. Alternatively, the user equipment of the first user may directly receive the contact information of the second user in a digital manner. Any other obtaining manner is also possible.

Next, the method 100 proceeds to step S104 where a social networking service (SNS) operation between the first user and the second user is initiated based on the contact information of the second user as obtained at step S102.

Term “SNS operation” as used here refers to various operations that are executed based on a SNS website, such as user interaction, data exchange, and information processing. Term “SNS website” refers to a website for providing a virtual community for people who are interested in a specific object or “wandering” together. After registration and login, members or subscribers of an SNS website may communicate through voice, chatter, instant message, video conference, and blog, etc. An SNS website generally provides to its members the ways of contacting other members.

According to embodiments of the present invention, the SNS operation as initiated at step S104 may comprise transmitting, on behalf of the first user, an SNS friend inviting message to the second user. Term “friend” here means members in an SNS website form a connection, association, or relation therebetween through the SNS website. The connection in the SNS website is generally bi-directional (but not compulsory), thus the term “friend” may depend on a reference frame. The connection between users may be a direct connection; however, some embodiments of an SNS website network allow an indirect connection via one-phase or multi-phase connection. Besides, the term “friend” does not compulsorily require the users to be friends in real life.

By sending a friend invitation to the second user, it is possible to facilitate the first user and the second user to establish a friend relationship in the SNS website, thereby facilitating their interaction and relation.

Alternatively or additionally, the SNS operation may comprise sending to the second user a link to a content or event associated with the first user in at least one SNS website. For example, a link, for example, in form of a uniform resource locator (URL), to a webpage associated with the first user (for example, the home page of the first user) may be sent to the second user. It is also possible to send to the second user a link to any suitable event and content such as an event, a post, a focus, a fresh thing, a piece of news of the first user in the at least one SNS website.

Further, the SNS operation may comprise sending to the second user the additional information of the first user in the SNS website, for example, interests, habits, education degree, etc. Such information, for example, may be obtained from a profile of the first user in the SNS website.

As another example, at step S104, the SNS operation may comprise recommending the friends of the first user in the at least one SNS website to the second user. For example, all friends of the first user in the SNS website may be recommended to the second user. Preferably, the friends potentially matching the second user among the friends of the first user may be selected to be recommended to the second user. For example, the friend recommendations may be generated based on the contact information about the second user and the information about friends of the first user in the SNS website (for example, obtained through profile information). Specifically, it is possible to search the friend(s) of the first user who has a similar characteristic to the second user. The similar characteristic here for example includes but not limited to one or more of the following: adjacency in geographical location, the same company or with a similar nature, a same or similar title, a same or similar educational degree, etc. The user information in the SNS website may be obtained through profile information. Those friends with similar attributes are then recommended to the second user in an SNS operation initiated at step S104. In this way, with the first user as a medium, the SNS relation of the second user may be expanded voluntarily based on his/her contact information.

At step S104, in addition or alternative to the SNS operation, other interactive operations may be initiated between the first user and the second user. For example, a notification message may be sent to the second user so as to notify the second user that its contact information has been added by the first user. The notification message may be implemented by any suitable means, for example, e-mail, short messaging service (SMS) message, a multi-media messaging service (MMS) message, etc. Optionally, the notification message may further carry personal information or contact information about the first user. It should be noted that this notification may be sent on behalf of the first user or sent on behalf of a third-party system.

As a further example, the interactive operation between the first user and the second user as initiated at step S104 may further comprise sending, on behalf of the first user, a private message to the second user and/or recommending the first and second users establishing a private connection. For example, such private message may be sent by virtue of the user equipment of the first user or other device. The private message may likewise be implemented by means of e-mail, SMS, MMS, etc.

At steps S102 and S104, in response to the first user storing the contact information of the second user, potential suitable relations and operations between the first and second users may be voluntarily found and initiated.

Hereinafter, subsequent alternative steps S106-S114 of method 100 will be described.

At optional step S106, the contact information of the second user may be transmitted from a user equipment of the first user to one or more server coupled to the user equipment. After receiving the contact information of the second user, the server may store the contact information in association with the second user and the uploader (i.e., the first user).

It should be noted that according to embodiments of the present invention, the user equipment and the server may be coupled by virtue of various kinds of suitable manners. For example, such coupling may comprise any cabled network, wireless network, regardless of whether they are currently known or future developed, or a combination thereof, including, but not limited to, at least one of the following: a cellular telephone network, Ethernet, a wireless local area network (WLAN) based on IEEE 802.11, 802.16, 802.20, and/or Worldwide Interoperability for Microwave Access (WiMAX) network. The network may be a public network (such as, Internet), a private network (for example, an intra network within an enterprise), or a combination thereof.

Next, at step S108, the server is searched for previous contact information (if present) that is already stored in association with the second user and uploaded by another user. It may be implemented, for example, by searching the storage of the server using one or more content items (for example, name, telephone number, ID number, etc.) in the contact information of the second user as index.

It is understood that steps S102-S108 are executed at the user equipment side of the first user. The optional steps S110-S114 that will be described hereinafter are executed at the server side.

The method 100 may proceed to step S110 to determine whether or not the stored previous contact information completely matches the contact information currently uploaded. In other words, at step S110, it is determined whether or not the current contact information associated with the second user is completely consistent with each content item of the previous contact information.

If the current contact information is not completely consistent with at least one content item in the previous contact information, it is deemed that the current content information of the second user does not match the previous contact information (branch “No” of step S110). At this point, method 100 proceeds to step S112. Otherwise, if the current contact information matches the previous contact information (branch “Yes” of step S110), then the method 100 may proceeds to step S114.

If the current contact information of the second user does not match the previous contact information, it may be deemed that the contact information of the second user has been updated or changed. Accordingly, at step S112, a message indicating such mismatch is transmitted to a third user who uploads the previous contact information of the second user. In this way, the third user may know that the contact information of the second user might have been changed.

Further, if allowed by the privacy setting, at step S112, the latest contact information (which may include all content items in the contact information, or at least include those content items that have changed in the contact information) of the second user which is transmitted by the first user may also be sent to the third user at step S112. In this way, the third user has an opportunity of updating his/her contact information about the second user.

It should be noted that in the case that step S112 is executed, the server may also optionally update or replace the previously stored contact information of the second user with the recently received contact information of the second user.

At step S114, an SNS operation at least involving the first, second, and third users may be initiated. The basic idea of step S114 is that since both the first and third users add the contact information of the second user, the first and third users might be interested in establishing an SNS relation therebetween. Thus, the second user may act as a bright to initiate an SNS operation between the first and third users. Optionally, the initiated SNS operation may further involve the second user, namely, the SNS operation simultaneously involve the first, second and third user. In other words, the SNS operation initiated at step S114 involves the first user and involves at least one of the second and third users.

The method 100 ends after step S114.

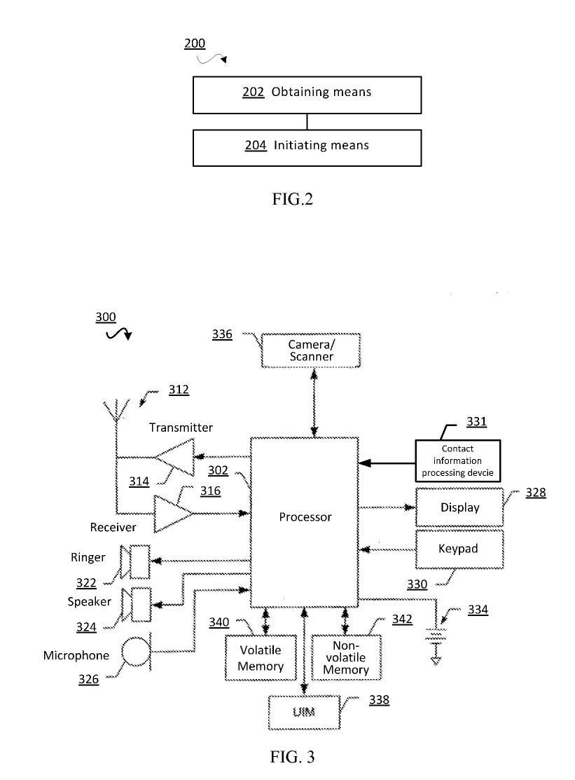

Now referring to FIG. 2, a block diagram of a system 200 of processing user contact information according to an exemplary embodiment of the present invention is illustrated.

As shown, the system 200 comprises: obtaining means 202 configured to obtain, at a user equipment of a first user, contact information associated with a second user; and initiating means 204 configured to initiate a social networking service SNS operation between the first user and the second user based on the contact information.

According to some optional embodiments of the present invention, the initiating means 204 includes at least one of the following: first initiating means configured to send to the second user an SNS friend inviting message on behalf of the first user; and second initiating means configured to send to the second user a link to a content or event associated with the first user in at least one SNS network.

According to some optional embodiments of the present invention, the initiating means 204 comprises: third initiating means configured to recommend one or more friends of the first user in the at least one SNS network to the second user. According to some optional embodiments of the present invention, the third initiating means comprises: recommendation generating means configured to generate the recommendation based on the contact information associated with the second user and the information of the one or more friends in the SNS website.

According to some optional embodiments of the present invention, the system 200 may further comprise: transmitting means configured to transmit the contact information associated with the second user from the user equipment to the server, so as to search the server previous for contact information associated with the second user as already stored by the third user.

According to some optional embodiments of the present invention, the system 200 may further comprise: message transmitting means configured to, in response to determining that the contact information mismatches the previous contact information, transmit a message indicating the mismatch to the third user. According to some optional embodiments of the present invention, the message transmitting means is further configured to include in the message transmitted to the third user content items in the contact information that is associated with the second user and transmitted by the user equipment of the first user to the server.

According to some optional embodiments of the present invention, the system 200 may further comprise: fourth initiating means configured to initiate an SNS operation between the first user and at least one user of the second user and the third user.

According to some optional embodiments of the present invention, the system 200 may further comprise notifying means configured to transmit a notification message to the second user to notify the second user that the first user has obtained the contact information.

According to some optional embodiments of the present invention, the obtaining means 202 comprises business card information obtaining means configured to obtain the contact information associated with the second user through perform digitalized scanning and recognition to the business card of the second user.

It should be noted that the system 200 may be a distributed system. That is, respective means and sub-means in the system 200 may be located physically separate locations or devices, respectively. It should be noted that for the sake of clarity, alternative means and sub-means comprised in respective means are not illustrated in FIG. 2. However, it should be understood that respective means specified in system 200 correspond to respective steps in method 100 as above described with reference to FIG. 1. Thus, the operations and features for describing method 100 are likewise applicable to the system 200 and the means comprised therein, which will not be detailed here.

It should be understood that the system 200 may be implemented in various manners. For example, in some embodiments, respective means in system 200 may be implemented using software and/or firmware modules. Alternatively or additionally, the system 200 may be implemented partially or completely based on hardware. For example, the means in system 200 may be implemented as an integrated circuit (IC) chip or dedicated integrated circuit (ASIC). The means in system 200 may be implemented as a system-on-chip (SOC). Other manners that are currently known or developed in the future are also feasible, and the scope of the present invention is not limited thereto.

Now referring to FIG. 3, a schematic block diagram of a mobile terminal 300 suitable for acting as the user equipment according to one embodiment of the present invention is illustrated. It should be understood that the mobile terminal is merely exemplary and non-limiting. Other types of portable user equipments may also act as the user terminal.

As illustrated in FIG. 3, the mobile terminal 300 comprises antenna 312 that operatively communicates with a transmitter 314 and a receiver 316. The mobile terminal 300 further comprises a processor 302 or other processing element, which provide a signal to the transmitter 314 and receive a signal from the receiver 316, respectively.

It should be understood that the processor 302 comprises a circuit required for implementing the function of the mobile terminal 300. For example, the processor 302 may comprise a digital signal processor device, a microprocessor device, various kinds of A/D converters or D/A converters, and other support circuits. The control and signal processing functions of the mobile terminal are allocated thereamong in accordance with respective capabilities of these devices.

The mobile terminal 300 may further comprise a user interface, for example, comprising a ringer 332, a earphone or speaker 324, a microphone 326, a display 328, and a keypad 330. All of these devices are coupled to the processor 302. The mobile terminal 300 may further comprise a camera/scanner 336 for capturing static and/or dynamic images and alternatively for recognizing words thereon.

The mobile terminal 300 further comprises a battery 334, such as a vibrating battery set, for supplying power to various circuits required for operating the mobile terminal 300 and alternatively providing mechanical vibration as detectable output. The mobile terminal 300 may further comprise a user identification module (UIM) 338.

The mobile terminal 300 further comprises a memory. For example, the mobile device 300 may comprise a volatile memory 340, for example, comprising a volatile random access memory (RAM) in a cache area for temporarily storing data. The mobile terminal 300 may further comprise other non-volatile memory 342 which may be embedded and/or movable. The non-volatile memory 342 may additionally or alternatively include for example, EEPROM and flash memory, etc.

Particularly, the mobile terminal 300 may comprise a contact information processing device 331, which, for example, is the example of system 200 as above described with reference to FIG. 2.

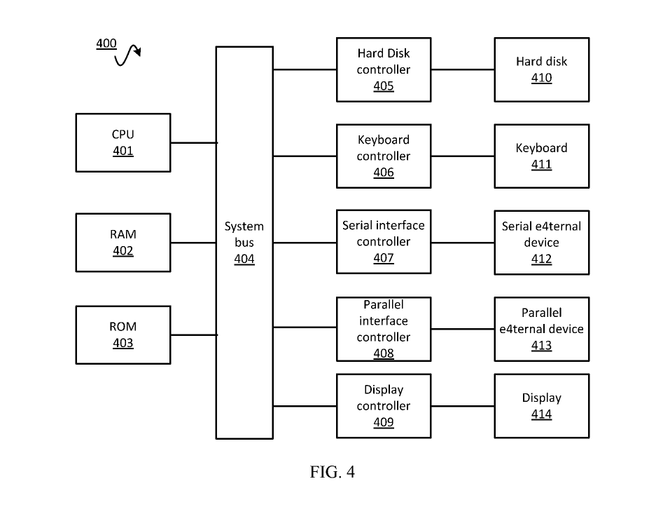

Now referring to FIG. 4, it illustrates a block diagram of a computer system 400 which is suitable for acting as the server or user equipment as mentioned in the present invention.

As illustrated in FIG. 4, the computer system includes a CPU (Central Processing Unit) 401, a RAM (Random Access Memory) 402, a ROM (Read Only Memory) 403, a system bus 404, a hard disk controller 405, a keyboard controller 406, a serial interface controller 407, a parallel interface controller 408, a monitor controller 409, a hard disk 410, a keyboard 411, a serial peripheral device 412, a parallel peripheral device 413 and a monitor 414. Among these components, connected to the system bus 404 are the CPU 401, the RAM 402, the ROM 403, the hard disk controller 405, the keyboard controller 406, the serial interface controller 407, the parallel interface controller 408 and the monitor controller 409. The hard disk 410 is coupled to the hard disk controller 405; the keyboard 411 is coupled to the keyboard controller 406; the serial peripheral device 412 is coupled to the serial interface controller 407; the parallel peripheral device 413 is coupled to the parallel interface controller 408; and the monitor 414 is coupled to the monitor controller 409. It should be understood that the structural block diagram in FIG. 4 is shown only for illustration purpose, and is not intended to limit the scope of the present invention. In some cases, some devices may be added or reduced as required.

As mentioned above, the means in the system 200 of processing user contact information may be implemented as pure hardware, for example, chip, ASIC, SOC, etc. Such hardware may be integrated into the computer system 400 acting as a user equipment and server, respectively. Besides, the embodiments of the present invention may also be implemented in a manner of computer program product. For example, the method 100 as described with reference to FIG. 1 may be implemented via a computer program product. This computer program product may be stored in RAM 404, ROM 404, hard disk 410 and/or any suitable storage medium as illustrated in FIG. 4, or downloaded to the computer system 400 from a suitable location in the network. The computer program product may comprise a computer code portion comprising a program instruction that may be executed through a suitable processing device (for example, CPU 401 in FIG. 4). The program instruction at least may comprise an instruction for implementing steps of method 100.

The spirit and principle of the present invention has been illustrated above with reference to a plurality of preferred embodiments. According to embodiments of the present invention, after the user inputs the contact information of other people in its user equipment, the contact information is not simply stored, but may be utilized to voluntarily find and initiate relations and operations between the user and other users. In particularly, an SNS operation may be performed between the first user and the second user, thereby establishing an SNS relation. Therefore, effective and intelligent utilization of the user contact information may be significantly facilitated.

It should be noted that, the embodiments of the present invention can be implemented in software, hardware or the combination thereof. The hardware part can be implemented by a special logic; the software part can be stored in a memory and executed by a proper instruction execution system such as a microprocessor or a dedicated designed hardware. The normally skilled in the art may understand that the above method and system may be implemented with a computer-executable instruction and/or in a processor controlled code, for example, such code is provided on a bearer medium such as a magnetic disk, CD, or DVD-ROM, or a programmable memory such as a read-only memory (firmware) or a data bearer such as an optical or electronic signal bearer. The apparatuses and their components in the present invention may be implemented by hardware circuitry of a programmable hardware device such as a very large scale integrated circuit or gate array, a semiconductor such as logical chip or transistor, or a field-programmable gate array, or a programmable logical device, or implemented by software executed by various kinds of processors, or implemented by combination of the above hardware circuitry and software.

The communication network as mentioned in this specification may comprise various kinds of networks, including but not limited to local area network (LAN), wide area network (WAN), an IP-protocol based network (for example Internet), and a peer-to-peer network (for example ad hoc peer network).

It should be noted that although a plurality of means or sub-means of the device have been mentioned in the above detailed depiction, such partitioning is merely non-compulsory. In actuality, according to the embodiments of the present invention, the features and functions of the above described two or more means may be embodied in one means. In turn, the features and functions of the above described one means may be further embodied in more means.

Besides, although operations of the present invention method are described in a particular order in the drawings, it does not require or imply that these operations must be performed according to this particular sequence, or a desired outcome can only be achieved by performing all shown operations. On the contrary, the execution sequences for the steps as depicted in the flowcharts may change. Additionally or alternatively, some steps may be omitted, a plurality of steps may be merged into one step, or a step may be divided into a plurality of steps for execution.

Although the present invention has been depicted with reference to a plurality of embodiments, it should be understood that the present invention is not limited to the disclosed embodiments. On the contrary, the present invention intends to cover various modifications and equivalent arrangements included in the spirit and scope of the appended claims. The scope of the appended claims meets the broadest explanations and covers all such modifications and equivalent structures and functions.

What is claimed is:

1. A method for processing user contact information, comprising:
obtaining, at a user equipment of a first user, contact information associated with a second user; and
initiating a social networking service SNS operation between the first user and the second user based on the contact information.

2. The method according to claim 1, wherein initiating an SNS operation between the first user and the second user comprises one of:
transmitting to the second user an SNS friend inviting message on behalf of the first user; and
transmitting to the second user a link to a content or event associated with the first user in at least one SNS network.

3. The method according to claim 1, wherein initiating an SNS operation between the first user and the second user comprises:
recommending one or more friends of the first user in at least one SNS website to the second user.

4. The method according to claim 3, wherein the recommendation is generated based on the contact information associated with the second user and information of the one or more friends in the SNS website.

5. The method according to claim 1, further comprising:
transmitting the contact information associated with the second user from the user equipment to a server; and
searching the server for previous contact information associated with the second user that is stored by a third user.

6. The method according to claim 5, further comprising:
in response to determining that the contact information mismatches the previous contact information, transmitting a message indicating the mismatch to the third user.

7. The method according to claim 6, wherein the message transmitted to the third user further comprises data items in the contact information associated with the second user that is transmitted to the server from the user equipment of the first user.

8. The method according to claim 5, further comprising:
initiating an SNS operation between the first user and at least one of the second user and the third user.

9. The method according to claim 1, further comprising:
transmitting a notification message to the second user to notify the second user that the first user has obtained the contact information.

10. The method according to any of claims 1-9, wherein the contact information associated with the second user is obtained by digitally scanning and recognizing a business card of the second user.

11. A system for processing user contact information, comprising:
obtaining means configured to obtain, at a user equipment of a first user, contact information associated with a second user; and
initiating means configured to initiate a social networking service SNS operation between the first user and the second user based on the contact information.

12. The system according to claim 11, where the initiating means comprises at least one of:
first initiating means configured to transmit to the second user an SNS friend inviting message on behalf of the first user; and
second initiating means configured to transmit to the second user a link to a content or event associated with the first user in at least one SNS network.

13. The system according to claim 12, wherein the initiating means comprises:
third initiating means configured to recommend one or more friends of the first user in at least one SNS website to the second user.

14. The system according to claim 12, wherein the third initiating means comprises:
recommendation generating means configured to generate the recommendation based on the contact information associated with the second user and information of the one or more friends in the SNS website.

15. The system according to claim 11, further comprising:
transmitting means configured to transmit the contact information associated with the second user from the user equipment to a server for searching the server for previous contact information associated with the second user that is stored by the third user.

16. The system according to claim 15, further comprising:
message transmitting means configured to, in response to determining that the contact information mismatches the previous contact information, transmit a message indicating the mismatch to the third user.

17. The system according to claim 16, wherein the message transmitting means is further configured to include in the message transmitted to the third user content items in the contact information associated with the second user that is transmitted by the user equipment of the first user to the server.

18. The system according to claim 15, further comprising:
fourth initiating means configured to initiate an SNS operation between the first user and at least one of the second user and the third user.

19. The system according to claim 11, further comprising:
notifying means configured to transmit a notification message to the second user to notify the second user that the first user has obtained the contact information.

20. The system according to any of claims 11-18, wherein the obtaining means comprises:
business card information obtaining means configured to obtain the contact information associated with the second user by digitally scanning and recognizing a business card of the second user.
